(19) United States
(12) Patent Application Publication
(10) Pub. No.: US 2021/0388639 A1
(43) Pub. Date: Dec. 16, 2021

(54) ELECTRIC LOCK SYSTEM

(71) Applicant: JWM Hi-Tech Development Co., Ltd., Shenyang (CN)

(72) Inventor: Xiaoyu E, Shenyang (CN)

(21) Appl. No.: 17/344,921

(22) Filed: Jun. 10, 2021

(30) Foreign Application Priority Data
Jun. 16, 2020 (CN) 202010545418.6

(51) Int. Cl. E05B 47/00

(52) U.S. Cl. CPC E05B 47/0045; E05B 49/002; E05B 47/0004

(57) ABSTRACT

An electric lock system, includes an electric lock and an electric key. The electric lock includes a lock body and a lock core, and the lock body has a key limit slot and a key limit slide. The lock core includes a T-shaped magnet, a solenoid and a lock pin. The T-shaped magnet is fixed to the lock core, and the lock pin is connected to the solenoid, the solenoid can generate a magnet field when energized, and the magnet field generate a force with the T-shaped magnet, and drives the lock pin to stop limiting the lock body. The electric key includes a lithium battery and a metal housing, and the metal housing has a key limit head corresponding to a shape of the key limit slot. The electric key provides electric power to the lock core by contacting the key limit head to the key limit slot.

### TECHNICAL FIELD

The present disclosure relates to a field of lock, and particularly to an electric lock system.

### BACKGROUND

The lock is an indispensable anti-theft tool in the daily life management of all walks of life. It is widely used in electric power, railways, public security, communications, petroleum and petrochemical, gas, water, logistics and transportation industries, as well as municipalities, enterprises and institutions. In industrial applications, it can protect key equipment and facilities from being stolen and destroyed, and facilitate unified management. Currently, there are many types of locks on the market, including conventional mechanical locks and emerging electric locks. Different types of locks have different structures and functions.

Generally, a conventional passive electric lock use the electric key to provide the power to the lock core, and issue the unlocking and locking instructions. The electric part of the lock core drives the mechanical part, allowing the electric key to be rotated, to drive the lock pin leave or enter the limit position, so as to realize the operation of unlocking or locking the lock.

At present, the conventional electric key drives the lock core to rotate. Most of the rotating parts have a simple mechanical structure. During the rotation, the electric key can be pulled out at any time, which will prevent the lock pin from fully entering or leaving the limit position, and the lock is not fully locked or unlocked. Therefore, it is easy to open the lock by malicious hitting, raising safety risk. Also, the above-mentioned locking and unlocking operation may make the electric part of the lock core hard to precisely determine the locking or unlocking state, causing troubles in system management.

### SUMMARY

According to the present disclosure, the key limit head is corresponding to the key limit slot, and the rotation of the electric key is limited in the key limit slot, so as to prevent the electronic key from being pulled out occasionally during the rotation while the lock/unlock operation of the electric key is allowed, resulting in the lock not being completely locked or the lock is in a false open state, and the final open and closed state cannot be accurately judged. Due to the limitation of the limit slot and limit slide, the electric key can only be pull out of the lock in its lock or unlock position, and the key cannot be pulled out optionally during the rotation process of the key. At the same time, the Hall component in the lock core can determine the state of locking or unlocking accurately, and record the state.

Accordingly, the present disclosure provided an electric lock system, which includes an electric lock and an electric key. The electric lock includes a lock body and a lock core, and the lock body is has a key limit slot and a key limit slide. The lock core includes a T-shaped magnet, a solenoid and a lock pin. The T-shaped magnet is fixed to the lock core, and the lock pin is connected to the solenoid, the solenoid can generate a magnet field when energized, and the magnet field generate a force with the T-shaped magnet, and drives the lock pin to stop limiting the lock body. The electric key includes a lithium battery and a metal housing, and the metal housing has a key limit head corresponding to a shape of the key limit slot. The electric key provides electric power to the lock core by contacting the key limit head to the key limit slot.

Optionally, the lock infrared communication board is located in the lock core, and a key infrared communication board is provided in the electric key. The lock core communicates to the key infrared communication board by the lock infrared communication board. The lock main board is provided in the lock core, the lock main board works if the lock core is energized, and determines whether a unlocking operation or a locking operation is allowed to be performed, an unlocking state and a locking state of the electric lock are uploaded to the electric key via the lock infrared communication board.

Optionally, the lock core further includes a lock core plastic part and a lock power positive pin embedded in the lock core plastic part. The connecting tip of the power positive pin is exposed from the lock core plastic part, and another tip of the lock power positive pin is in communication with the lock infrared communication board. The electric key further includes a key power positive pin, and the key power positive pin is in touch with the lock power positive pin if the key limit head is in touch with the key limit slot, thereby providing electric power to the lock core.

Optionally, a Hall magnetic sensor is located in the lock core, and the Hall magnetic sensor is synchronously rotatable with the lock core.

Optionally, the electric lock further comprises a key limit rack fixed to the lock body via a screw, and the key limit slide is formed between the key limit rack and the lock body.

Optionally, a lock core sleeve is sleeved on the lock core plastic part, and the lock core sleeve and the lock core plastic part both have a position hole aligned with each other.

Optionally, the lock core further includes a connecting part fixed to the lock core sleeve, and the connecting part is synchronously rotatable with the lock core. An arc-shaped position pin limit slot is defined on the connecting part, and an angular degree of the position pin limit slot is the same as a rotatable angular degree of the lock core

Optionally, a position pin is located in the lock body, an end of the position pin is fixed in the lock body, and another end of the position pin is inserting into the position pin limit slot, thereby connecting the lock body to the lock core sleeve.

Optionally, the electric lock further includes a lock beam, a limit ball and a lock beam spring. The lock beam is mounted in the lock body to fix and compress the lock beam spring, and the limit ball is mounted in the lock body, so as to limit the lock beam.

If the lock core is energized and the lock main board determines to operate the unlocking operation, the solenoid is energized to generate the magnetic field, the magnet field generate the force with the T-shaped magnet, the solenoid moves to the T-shaped magnet and drives the lock pin to stop limiting the lock body. If the electric key rotates clockwise, the key limit head rotates clockwise in the key limit slide, so as to drive the connecting part to rotate, such that the limit ball enters one of the platforms at both sides of the connecting part, the limit ball stops limiting the lock beam, and the lock beam spring ejects the lock beam.

If the lock core is energized and the lock main board determines to operate the locking operation, the solenoid is energized to generate the magnetic field, the magnet field generate the force with the T-shaped magnet, the solenoid moves to the T-shaped magnet and drives the lock pin to stop limiting the lock body Then the lock beam is returned to an initial position, and the electric key rotates counterclockwise, the key limit head rotates counterclockwise in the key limit slide, so as to drive the connecting part to rotate, such that the key limit head slides counterclockwise in the key limit slide and drives the connecting part to rotate, and drive the limit ball to limit the lock beam.

### BRIEF DESCRIPTION OF THE DRAWINGS

FIG. 1 is an explosive view of the electric lock system according to an embodiment of the present disclosure;

FIG. 2 is a cross-sectional view of the electric lock according to an embodiment of the present disclosure;

FIG. 3 is a cross-sectional view of the electric lock of FIG. 2 in an unlocking state;

FIG. 4 is a top view of the electric key according to an embodiment of the present disclosure;

FIG. 5 is a cross-sectional view of the electric key according to an embodiment of the present disclosure;

FIG. 6 is a perspective view of the lock core according to an embodiment of the present disclosure;

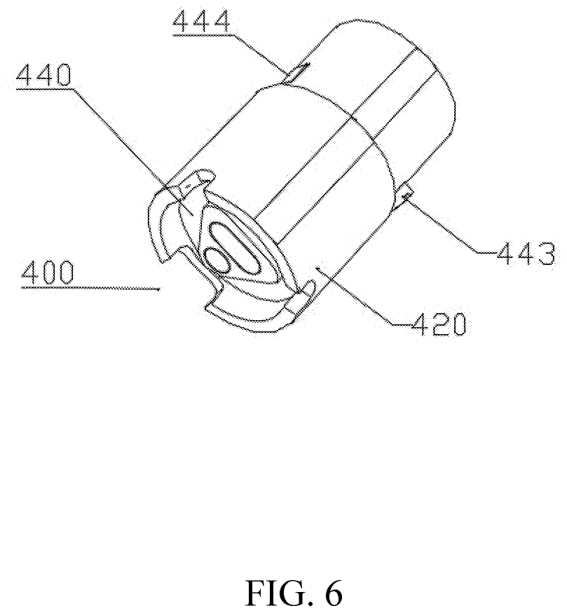

FIG. 7 is an explosive view of the lock core according to an embodiment of the present disclosure;

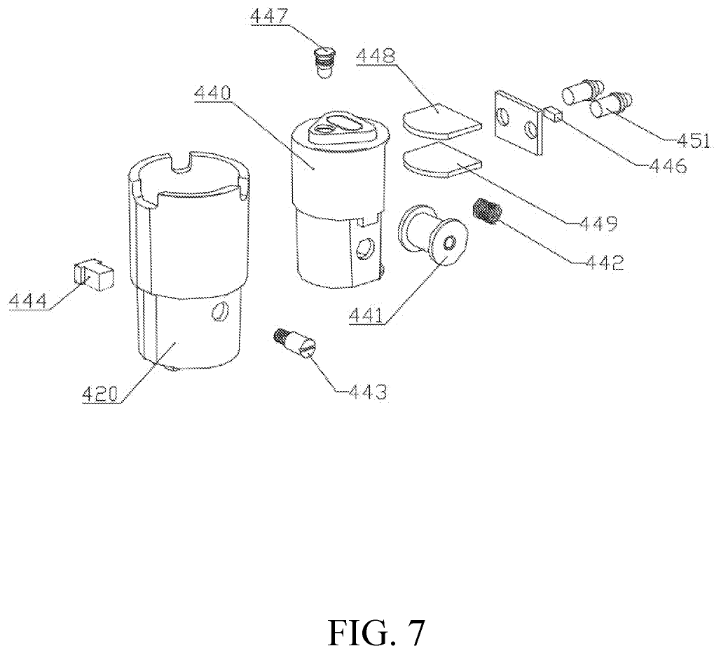

FIG. 8 is perspective view of the connecting part in the unlock position according to an embodiment of the present disclosure;

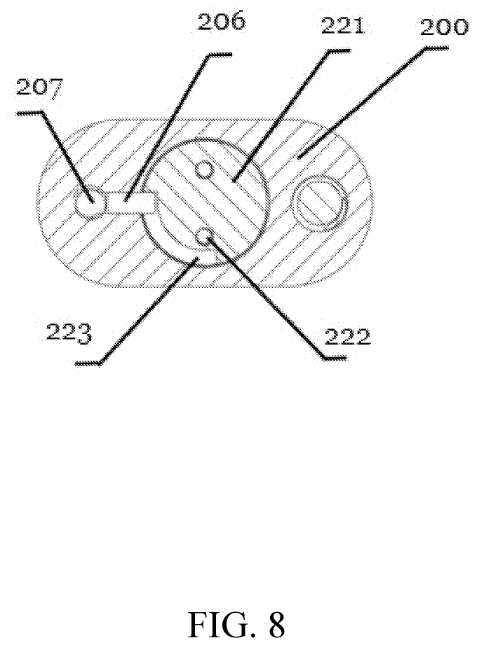

FIG. 9 is perspective view of the connecting part in the clock position according to an embodiment of the present disclosure

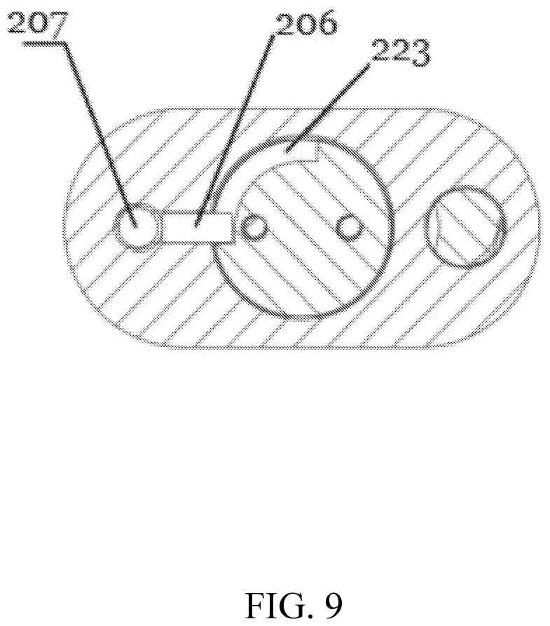

FIG. 10 is a bottom view of the electric lock according to an embodiment of the present disclosure; and

FIG. 11 is a bottom view of the limiting rack of FIG. 10.

### DETAILED DESCRIPTION OF THE EMBODIMENTS

The present disclosure will be further described in detail below with reference to the drawings. The preferred embodiment in the following description is taken as an example, and those skilled in the art may make other obvious variations. The basic principles of the present invention defined in the following description can be applied to other embodiments, modifications, improvements, equivalents, and other technical solutions that do not deviate from the spirit and scope of the present disclosure.

The terms “upper”, “inner”, “center”, “left”, “right”, and “one” cited in this specification are only for ease of description and are not intended to limit the scope of the present disclosure. The change or adjustment of the relative relationship of the elements, without substantial changes to the technical content, shall also be regarded as the scope within which the present disclosure can be implemented.

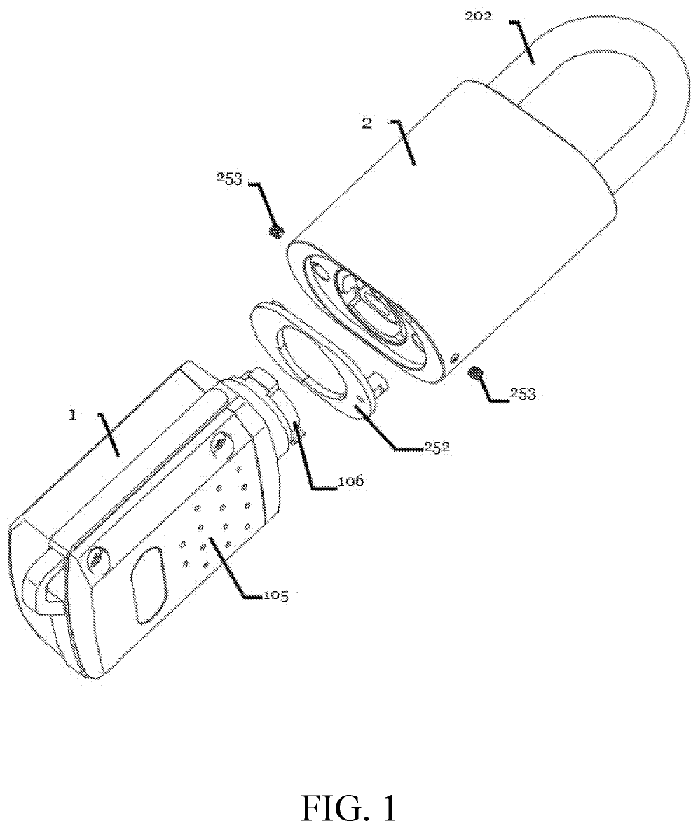

Referring to FIG. 1, an embodiment of the present disclosure provides an electric lock system, including the electric lock I and the electric key 2.

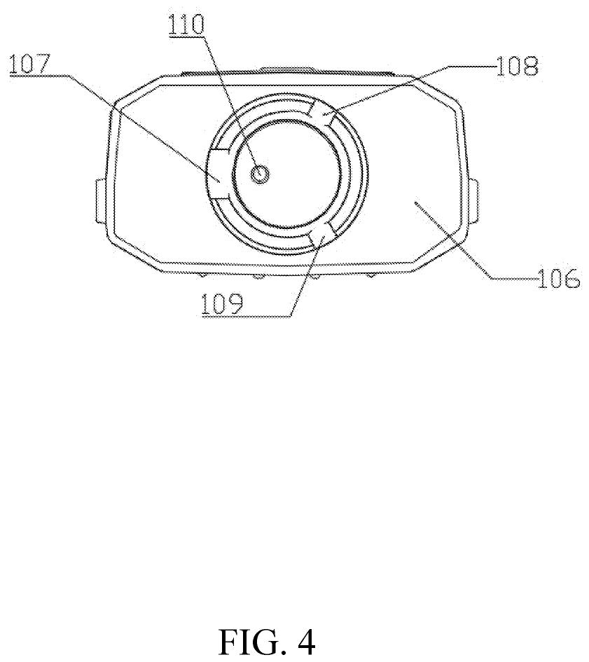

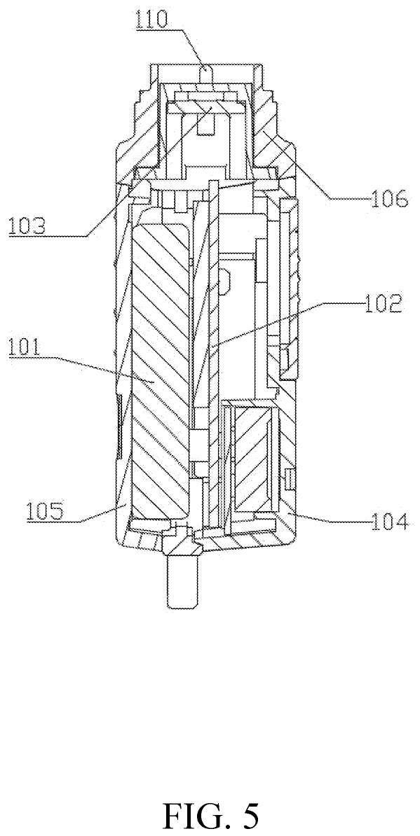

Specifically, as shown in FIGS. 4 and 5, the electric key includes a key lithium battery 101, a key main board 102, a key communication board 103, a key front housing 104, a key rear housing 105, and a key metal housing 106. The metal housing 106 has three key limit heads 107,108, and 109.

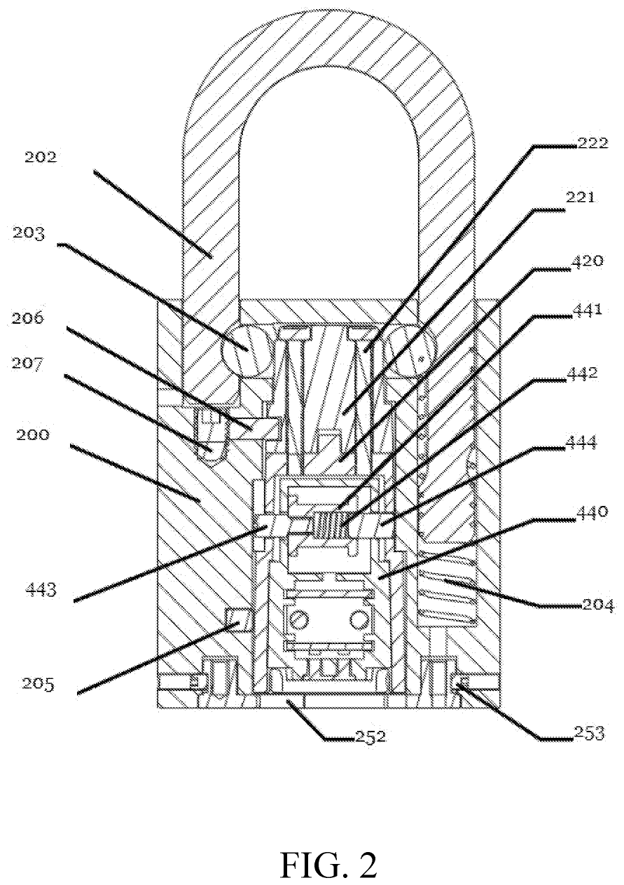

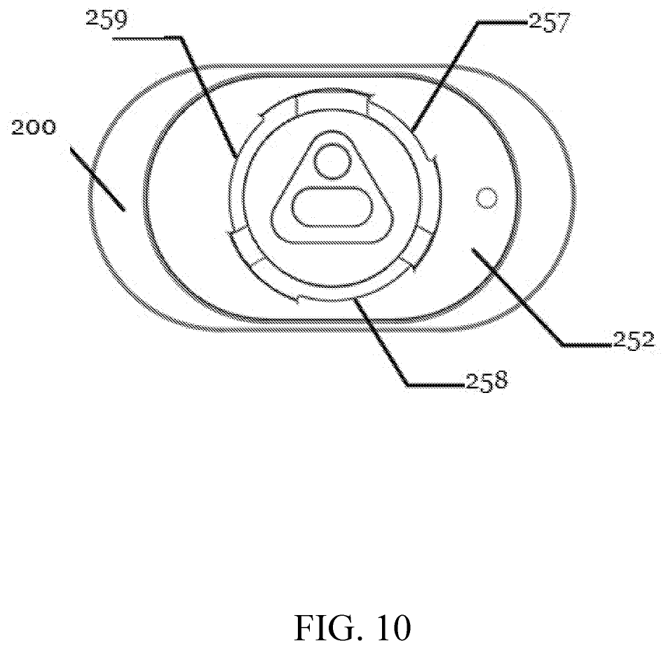

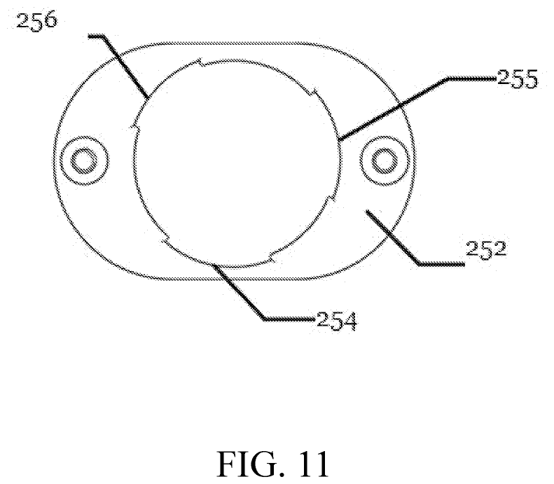

Correspondingly, referring to FIG. 2, the electric lock includes the lock body 200 and the lock core 400. The lock body 200 has three key limit slots 254, 255, and 256 corresponding to the key limit heads 107,108, and 109, as shown in FIG. 11, and also has three key limit slides 257, 258, and 259 connected to the key limit slots 254, 255, and 256, as shown in FIG. 10. The lock core 400 includes a T-shaped magnet 444, a solenoid 441 and a lock pin 443. The T-shaped magnet 444 is fixed to the lock core 400, and the lock pin 443 is connected to the solenoid 441, the solenoid 441 can generate a magnet field when energized, and the magnet field generate a force with the T-shaped magnet 444, then drives the lock pin 443 to stop limiting the lock body 200.

In order to achieve the communication and control between the components in the electric lock system, the lock infrared communication board 448 is located in the lock core 400, and a key infrared communication board is set in the electric key 1. The lock core 400 is communicates with the key infrared communication board by the lock infrared communication board 448. The lock main board 449 is located in the lock core 400, the lock main board 449 works if the lock core 400 is energized, and determines whether a unlocking operation or a locking operation is allowed to be performed, the unlocking state and locking state of the electric lock 1 are uploaded to the electric key 2 by the lock infrared communication board 448.

In one of the embodiments, the electric lock 2 further includes a lock beam 202, a limit ball 203, a lock beam spring 204, a Hall cylinder magnet 205, a position pin 206, set screws 207 and 253, a connecting part 221, a Phillips screw 222, and a key limit rack 252. The connecting part 221 is fixed to the lock core sleeve 420 by the Phillips screw 222, the plastic part 440 in inserted into the lock core sleeve 420, and the lock core sleeve 420 and the lock core plastic part 440 are both have a position hole aligned with each other. The connecting part 221 is synchronously rotatable with the lock core 400, and an arc-shaped position pin limit slot 223 is defined on the connecting part 221. The angular degree of the position pin limit slot 222 is the same as the rotatable angular degree of the lock core 440, which are both 90° in the illustrated embodiment. One end of the lock beam spring 204 is in contact with the bottom of the lock beam 202, and the other end is in contact with the inside of the lock body 200 and is compressed. The limit ball 203 is installed in the lock body 200 for limiting the lock beam 202 by placing the limit ball 203 into the notch on the lock beam 202. An end of the position pin 206 is fixed in the lock body 200 by the set screw 207, and another end of the position pin 206 is inserting into the position pin limit slot 223, thereby connecting the lock body 200 to the lock core 400.

The lock core 400 also has a limit spring 442, a Hall magnetic sensor 446. a power positive pin 447 and a power negative pin 451. The T-shaped magnet 444 extends through the position holes of the lock core sleeve 420 and the lock core plastic part 440, one end of the T-shaped is fixed to the lock core plastic part 440, and another end is inserted into the solenoid 441. One end of the lock pin 443 extends through the position holes of the lock core sleeve 420 and the lock core plastic part 440, and another end is mounted to the solenoid 441. The limit spring 442 is located in the solenoid 441, and namely located between the inserted part of the T-shaped magnet 444 and the lock pin 443. In the illustrated embodiment, the solenoid 441 is wound with a coil, and the solenoid 441 is made of a non-magnetic material.

When the electric key 1 is inserted into the electronic lock 2, the power positive pin 447 of the lock core 400 is in contact with the electric key positive pin 110, and at the same time the three limit slots of the lock cylinder sleeve 420 are in contact with the the key limit heads 107, 108, and 109 located on the key metal housing 106, such that a loop is formed, so that the lithium battery 101 in the electric key 1 energizes the electric lock 2, such that the lock main board 449 determines whether performs unlocking or locking operation.

If the lock main board 449 determines to operate the locking or unlocking operation, the lock core 400 is energized, such that the solenoid 441 is energized to generate the magnetic field, the magnet field generate the force with the T-shaped magnet 444, therefore the solenoid 441 moves to the T-shaped magnet 444. The solenoid 441 drives the lock pin 442 to compress the limit spring 442, such that the lock pin 443 is retracted from the position hole into the lock core 442. In this situation, the lock core 400 is not limited to the lock body 200, and rotating the electric key 2 can drive the lock core 400 to rotate in the lock body 200.

In one of the embodiments, the Hall magnetic sensor 446 is set in the lock core 400, and is synchronously rotatable with the lock core 400, so as to sense whether the lock core 400 is in an unlocking state or a locking state.

In one of the embodiments, the lock main board 449 determines the unlocking state or locking state of the electric lock system, and the unlocking state or locking state is uploaded to the electric key 2 by the lock infrared communication board 448.

Referring to FIG. 2, the lock beam 202 is mounted in the lock body 200, fixing and compressing the lock beam spring 204. The set screw 207 is mounted in the lock body 200, fixing the position pin 206. If the unlocking operation is performed, the electric key 1 rotates clockwise, the lock core 400 is driven to rotate in the lock body 200, so as to drive the connecting part 221 to rotate, such that the limit ball 203 enters one of the platforms at both sides of the connecting part 221, and the lock beam spring 204 ejects the lock beam 202.

According to the electric lock system of the embodiment, since the key limit rack 252 is fixed in the lock body 200 by the set screw 253, the electric key 1 can only be pull out of the electric lock 2 in its lock or unlock position, and the key 1 cannot be pulled out optionally during the rotation process of the key 1 inserted in the lock core 400.

In one of the embodiments, the metal housing 106 has three key limit heads 107,108, and 109. Referring to FIG. 11, three key limit slots 254, 255, and 256 corresponding to the key limit heads 107,108, and 109 are located on the key limit rack 252, the key limit rack 252 is fixed to the lock body 200 by the set screw 253, and the key limit slots 254, 255, and 256 are formed between the fixed key limit rack 252 and the lock body 200.

According to the electric lock system according to an embodiment of the present disclosure, the specific operation principle includes: when the electric key 1 is inserted into the electric lock 2, the electric key 1 contacts the lock core 400, and the key limit heads 107, 108, 109 enter the corresponding key limit slots 254, 255, and 256 of the key limit rack 252, respectively.

If the lock main board 449 determines to operate the locking or unlocking operation, the lock core 400 is energized, such that the solenoid 441 is energized to generate the magnetic field, the magnet field generate the force with the T-shaped magnet 444, therefore the solenoid 441 moves to the T-shaped magnet 444. The solenoid 441 drives the lock pin 442 to compress the limit spring 442, such that the lock pin 443 is retracted from the position hole into the lock core 442. In this situation, the lock core 400 is not limited to the lock body 200, and rotating the electric key 2 can drive the lock core 400 to rotate in the lock body 200. When the key 1 rotates, the key limit heads 107, 108, and 109 rotate clockwise or counterclockwise in the key limit slides 257, 258, 259, The electric key 1 can only be separated from the electric lock 2 at its unlock position (90°) and lock position (0°).

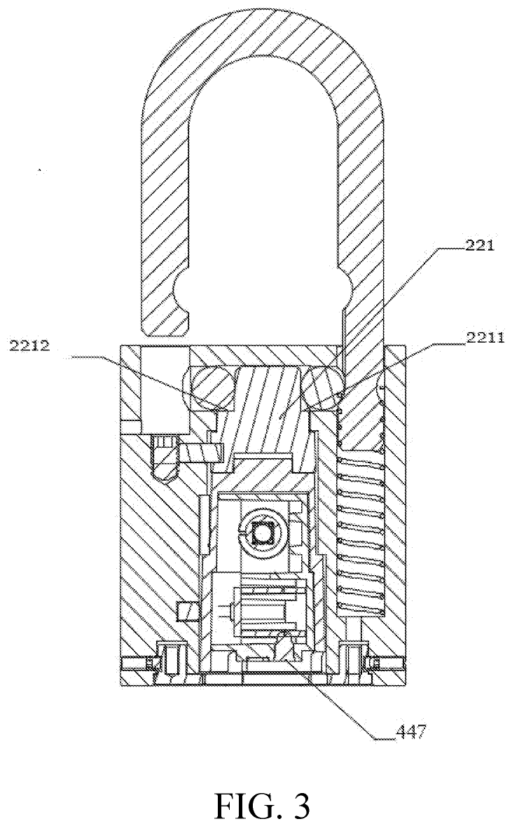

As shown in FIG. 3, in the unlocking operation, the key limit heads 107, 108, and 109 rotate clockwise in the key limit slides 257, 258, and 259, so as to drive the connecting part 221 to rotate, such that the limit ball 203 enters one of the platforms 2211 and 2212 at both sides of the connecting part 221, the lock beam spring 204 ejects the lock beam 202, such that the unlocking operation is performed.

In the locking operation, the lock beam 202 is pushed back, compressing the lock beam spring 204 back to its initial state, then the key limit heads 107, 108, and 109 rotate counterclockwise in the key limit slides 257, 258, and 259, so as to drive the connecting part 221 to rotate, such that the limit ball 203 moves back from the platforms 2211 and 2212 at both sides of the connecting part 221 to its initial position, so as to limit the lock beam 202 in a fixed position, such that the locking operation is performed.

The detailed embodiments are merely an explanation of the present disclosure, but not a limitation. And those skilled in the art may, after reading the specification, make modifications to the embodiments as necessary without contributing to the inventive step, provided that they are protected by patent law within the scope of the claims.

What is claimed is:

1. An electric lock system, comprising:
an electric lock, comprising a lock body and a lock core, and the lock body is provided with a key limit slot and a key limit slide; and the lock core comprises a T-shaped magnet, a solenoid and a lock pin, the T-shaped magnet is fixed to the lock core, and the lock pin is connected to the solenoid, the solenoid is capable of generating a magnet field when energized, and the magnet field generate a force with the T-shaped magnet, and drives the lock pin to stop limiting the lock body; and
an electric key, comprising a lithium battery and a metal housing, and the metal housing is provided with a key limit head corresponding to a shape of the key limit slot;
wherein the electric key is capable of providing electric power to the lock core via contacting the key limit head to the key limit slot.

2. The electric lock system according to claim 1, wherein a lock infrared communication board is provided in the lock core, and a key infrared communication board is provided in the electric key, and the lock core is capable of communicating with the key infrared communication board via the lock infrared communication board; and
a lock main board is provided in the lock core, the lock main board works if the lock core is energized, and determines whether a unlocking operation or a locking operation is allowed to be performed, an unlocking state and a locking state of the electric lock are uploaded to the electric key via the lock infrared communication board.

3. The electric lock system according to claim 2, wherein the lock core further comprises a lock core plastic part and a lock power positive pin embedded in the lock core plastic part, and a connecting tip of the power positive pin is exposed from the lock core plastic part, and another tip of the lock power positive pin is in communication with the lock infrared communication board; the electric key further comprises a key power positive pin, and the key power positive pin is in touch with the lock power positive pin if the key limit head is in touch with the key limit slot, thereby providing electric power to the lock core.

4. The electric lock system according to claim 1, wherein a Hall magnetic sensor is provided in the lock core, and the Hall magnetic sensor is synchronously rotatable with the lock core.

5. The electric lock system according to claim 1, wherein the electric lock further comprises a key limit rack fixed to the lock body via a screw, and the key limit slide is formed between the key limit rack and the lock body.

6. The electric lock system according to claim 3, wherein a lock core sleeve is sleeved on the lock core plastic part, and the lock core sleeve and the lock core plastic part are both provided with a position hole aligned with each other.

7. The electric lock system according to claim 6, wherein the lock core further comprises a connecting part fixed to the lock core sleeve, and the connecting part is synchronously rotatable with the lock core; an arc-shaped position pin limit slot is defined on the connecting part, and an angular degree of the position pin limit slot is the same as a rotatable angular degree of the lock core.

8. The electric lock system according to claim 7, wherein a position pin is provided the lock body, an end of the position pin is fixed in the lock body, and another end of the position pin is inserting into the position pin limit slot, thereby connecting the lock body to the lock core sleeve.

9. The electric lock system according to claim 7, wherein the electric lock further comprises a lock beam, a limit ball and a lock beam spring, the lock beam is mounted in the lock body to fix and compress the lock beam spring, and the limit ball is mounted in the lock body, so as to limit the lock beam.

110. The electric lock system according to claim 9, wherein if the lock core is energized and the lock main board determines to operate the unlocking operation, the solenoid is energized to generate the magnetic field, the magnet field generate the force with the T-shaped magnet, the solenoid moves to the T-shaped magnet and drives the lock pin to stop limiting the lock body; if the electric key rotates clockwise, the key limit head rotates clockwise in the key limit slide, so as to drive the connecting part to rotate, such that the limit ball enters one of the platforms at both sides of the connecting part, the limit ball stops limiting the lock beam, and the lock beam spring ejects the lock beam.

11. The electric lock system according to claim 9, wherein if the lock core is energized and the lock main board determines to operate the locking operation, the solenoid is energized to generate the magnetic field, the magnet field generate the force with the T-shaped magnet, the solenoid moves to the T-shaped magnet and drives the lock pin to stop limiting the lock body; if the lock beam is returned to an initial position, and the electric key rotates counterclockwise, the key limit head rotates counterclockwise in the key limit slide, so as to drive the connecting part to rotate, such that the key limit head slides counterclockwise in the key limit slide and drives the connecting part to rotate, and drive the limit ball to limit the lock beam.
